(19) United States
(12) Patent Application Publication
(10) Pub. No.: US 2019/0030860 A1
(43) Pub. Date: Jan. 31, 2019

(54) ACOUSTIC PLASTERBOARD

(71) Applicant: SAINT-GOBAIN PLACO, Suresnes (FR)

(72) Inventors: Katarzyna CHUDA, Asniere Sur Seine (FR); Caroline DEMATHIEU-ROELTGEN, Meaux (FR); Véronique CHOPIN, Bruyeres Sur Oise (FR)

(21) Appl. No.: 16/069,731

(22) PCT Filed: Jan. 11, 2017
(86) PCT No.: PCT/FR2017/050061

§ 371 Date: Jul. 12, 2018

(30) Foreign Application Priority Data
Jan. 13, 2016 (FR) 1650247

(51) Int. Cl. B32B 13/02; B32B 13/08; B32B 13/14; B32B 5/02; B32B 5/26; E04C 2/04; E04C 2/28; E04B 1/86

(52) U.S. Cl. CPC B32B 13/02; E04B 2001/8461; B32B 13/14; B32B 5/022; B32B 5/26; E04C 2/043; E04C 2/28; E04B 1/86; B32B 2260/021; B32B 2260/044; B32B 2262/0253; B32B 2262/0246; B32B 2262/0284; B32B 2262/14; B32B 2264/108; B32B 2307/102; B32B 2607/00; B32B 13/08

(57) ABSTRACT

A plaster-based board includes a core made of plaster positioned between two coating layers, in which a textile including fibers of a thermoplastic polymer constitutes at least one of the coating layers and/or the textile is embedded in the plaster constituting the core.

The invention relates to a plaster-based board endowed with acoustic properties. Such a board can be used in particular to produce a wall, ceiling or floor covering, and a partition wall.

Plaster-based boards are generally composite boards comprising a core made of plaster positioned between two coating layers made of paper or of cardboard. These boards have mechanical properties which meet the standards in force, in particular a good resistance to deflection under load.

Plaster-based boards as such do not exhibit particular acoustic performance levels. When it is desired to improve these performance levels, it is known to combine said board with a sound-insulating material, such as a glass or rock wool or a polymer, in order to form a composite product. This composite product can be held in place by means of profiled elements, of an adhesive, of screws or of dowels, according to the targeted use.

The commonest plaster-based boards have a mean thickness of 12.5 mm and are generally sold under the “BA 13” name. These boards exhibit a weight per unit area of the order of 9 kg/m². It is admittedly well known that it is possible to improve the acoustic performance levels of a board by increasing its weight per unit area, for example up to 12 kg/m², without modifying its thickness, but this is necessarily reflected by an increase in the amount of plaster in the board.

For this reason, the cost of the board is higher.

The installation of a board with a higher weight per unit area also presents disadvantages: because of the increase in the weight, the board is more problematic and testing to handle and also, owing to the fact that the board is denser, it is more difficult to penetrate through it when the attaching to the support is carried out using screws. These disadvantages become serious when the board has be attached at height, for example to a ceiling or to produce a partition.

It is an aim of the present invention to provide a plaster-based board which exhibits improved acoustic properties, while retaining good mechanical properties.

This aim is achieved according to the invention by replacing at least one of the coating layers made of paper or of cardboard of the plaster-based board with a textile comprising thermoplastic polymer fibers and/or by incorporating said textile in the core made of plaster.

The plaster-based board thus comprises a textile including fibers of a thermoplastic polymer which constitutes the coating layer or layers of the core made of plaster and/or which is embedded in the plaster constituting the core.

“Textile” is understood to mean a nonwoven, existing in particular in the form of a nap or of a mat, or a fabric.

The textile in accordance with the invention includes at least 70% by weight of fibers composed of at least one thermoplastic polymer.

Mention may be made, as examples of such thermoplastic polymers, of polyolefins, such as polyethylene, polypropylene, poly(l-butene) and polymethylpentene; polyamides in the form of homopolymers or copolymers, such as Nylon® 6-6, 6-9, 6-12, 10, 11 and 12, and polyamide-imide; homopolymers and copolymers of acrylonitrile, in particular acrylonitrile/styrene, acrylonitrile/methyl methacrylate, acrylonitrile/butadiene/styrene and acrylonitrile/styrene/acrylate; polyimides; polyesters, such as poly(alkylene terephthalate)s, in particular polyethylene terephthalate (PET) and polybutylene terephthalate (PBT), and poly(alkylene naphthalate)s, in particular polyethylene naphthalate; poly(lactic acid)s; polyhydroxyalkanoates; vinyl polymers, such as poly(vinyl alcohol), poly(vinyl acetate), poly(vinyl chloride) and poly(vinyl fluoride); copolymers of ethylene and of a vinyl compound, in particular of ethylene and of vinyl acetate (EVA) and of ethylene and of vinyl alcohol (EVAL); (meth)acrylic acid polymers, such as poly((meth)acrylic acid)s and copolymers of ethylene and of (meth)acrylic acid; alkyl (meth)acrylate polymers, in particular polymethyl methacrylate; polycaprolactones; polystyrenes; polymers of styrene and of an anhydride, in particular of maleic anhydride; copolymers of an olefin and of a fluorinated monomer, in particular poly(tetrafluoroethylene), poly(ethylene/tetrafluoroethylene), perfluoroethylene/propylene and poly(chlorotrifluoroethylene); polycarbonates; polyketones; polyetherketones; polyethersulfones; polyimides; and linear polyurethanes. Polypropylene, (meth)acrylic acid or (meth)acrylate polymers, poly(lactic acid)s, polyhydroxyalkanoates, PET, PBT and polyethylene naphthalate are preferred. Polypropylene, (meth)acrylic acid or (meth)acrylate polymers and PET are particularly preferred.

Advantageously, the textile includes a mixture of at least two different thermoplastic polymer fibers, in particular a mixture of polypropylene fibers and of (meth)acrylic acid or (meth)acrylate polymer fibers or of polypropylene fibers and of PET fibers. In this case, the amount of polypropylene fibers represents from 10 to 90% of the total weight of the thermoplastic polymer fibers, is preferably at least equal to 50% and advantageously is at least equal to 70%.

The thermoplastic polymer fibers can be monofilament fibers or multifilament fibers consisting of several monofilaments. The fibers are continuous in the case of a fabric and can be continuous or cut in the case of a nonwoven.

These fibers exhibit a linear density which generally varies from 1 to 25 dtex, preferably from 3 to 15 dtex and advantageously from 5 to 12 dtex. The length of the cut fibers varies from 0.5 to 15 cm, preferably from 1 to 10 cm and advantageously from 2 to 8 cm.

The thermoplastic polymer fibers can have a simple or multilobal section, advantageously a trilobal, tetralobal or pentalobal section. The lobes can exhibit a rounded shape or comprise sharp edges. The shape of the lobes can be complex, for example T- or Y-shaped, and each lobe can exhibit several branchings.

It is known to define, for multilobal fibers, a modification ratio which corresponds to the ratio of the diameter (R) of the circumscribed circle of the section of the fibers to the diameter (r) of the inscribed circle. This ratio R/r is preferably between 2 and 7 and advantageously between 3 and 6.

The multilobal fibers are advantageously polypropylene, PET or Nylon® fibers.

Such multilobal fibers are described in particular in EP 0 201 812 and EP 2 272 999.

The textile can include up to 30% by weight of fibers based on a nonthermoplastic polymer, in particular unmodified cellulose fibers, such as cotton or wood fibers, or chemically modified cellulose fibers, such as viscose or rayon fibers. The fibers can also be glass fibers provided in the form of individual filaments having a diameter which varies from 5 to 30 μm, of strands comprising a plurality of these glass filaments (base strand) or of an assemblage of several base strands (rovings). The linear density of the glass strands varies from 30 to 1500 tex.

When the textile is a nonwoven, the thermoplastic polymer fibers and optionally the other fibers based on a nonthermoplastic polymer or on glass are bonded together conventionally, for example by a mechanical treatment, in particular by needling or air jet, or by a heat treatment, in particular by spun bonding, which consists in bonding the fibers by heat immediately after having been spun or extruded.

It is possible to consolidate the textile, bonded mechanically or thermally, by using an aqueous binder which contains at least one polymer chosen from copolymers of an olefin, such as ethylene, propylene, butylene or isobutylene, and of vinyl acetate, copolymers of vinyl acetate and of (meth)acrylic acid or of acrylate, copolymers of (meth)acrylate and of a monomer other than vinyl acetate, in particular styrene, homopolymers of (meth)acrylic acid or of acrylate, terpolymers of vinyl acetate, of an olefin and of a vinyl ester monomer, and acrylonitrile polymers, in particular copolymers of acrylonitrile and of (meth)acrylate, especially of acrylonitrile and of methyl methacrylate, and terpolymers of acrylonitrile, of butadiene and of styrene. Copolymers of (meth)acrylate and of styrene are preferred, in particular copolymers of butyl acrylate and of styrene.

Advantageously, the glass transition temperature (Tg) of the polymers participating in the composition of the binder varies from −50 to +80° C., preferably from −40 to +60° C., advantageously from −10 to +25° C. and better still from 0 to +10° C., measured by differential scanning calorimetry according to the standard ISO 11357-1:2009.

The application of the binder to the textile can be carried out by any means known to a person skilled in the art, for example by spraying, impregnation or coating.

The textile generally exhibits a weight per unit area which varies from 50 to 800 g/m², preferably from 60 to 500 g/m² and advantageously from 80 to 300 g/m².

The textile can be composed of several identical or different textiles bonded together by a mechanical or heat treatment and the assemblage of these textiles can be consolidated by means of an aqueous binder, as is described above.

The core of the board is obtained from a plaster-based composition which comprises calcined gypsum and optional additives.

The core can thus comprise the following additives in the following proportions by weight, expressed as parts per 100 parts by weight of plaster:
from 0.1 to 25 parts of an adhesion agent, the role of which is to increase the adhesion with the plaster of the coating when the latter is made of paper or of cardboard, preferably at most 15 parts,
from 0.001 to 10 parts of a setting accelerator, for example calcium sulfate hydrate or potassium sulfate,
from 0.001 to 10 parts of a setting retarder,
from 0 to 10 parts of a biocide, for example sodium omadine,
from 0.0001 to 1 part of a foaming agent, the role of which is to create pores in order to reduce the density of the final product. Mention may be made, by way of example, of sodium alkyl ether sulfates and sodium lauryl sulfate,
from 0 to 10 parts of at least one water repellent, for example a siloxane or a polysiloxane,
from 0 to 20 parts of at least one flame retardant, for example vermiculite, silica, in particular of micrometric size, a clay or metal fibers,
from 0 to 20 parts of at least one reinforcing agent, for example polymer fibers, mineral fibers, in particular glass fibers, and animal or plant fibers.

Preferably, the adhesion agent is a starch, in particular pretreated with an acid, a dextrin, a vegetable flour, in particular a wheat or corn flour, a cellulose derivative, for example a methylcellulose or a hydroxymethylcellulose, a vinyl polymer, for example a polyvinyl alcohol, a polyvinyl acetate or an ethylene/vinyl acetate copolymer, a (meth)acrylic acid or alkyl (meth)acrylate polymer, for example a polymethyl methacrylate, a polyvinylpyrrolidone, in particular crosslinked by a polystyrenesulfonate, a styrene/butadiene latex, a polyester resin or an epoxy resin.

Preferably again, the reinforcing agent consists of at most 5 parts of glass fibers having a length varying from 3 to 12.5 mm and a diameter varying from 5 to 50 μm, preferably at most 3 parts.

The plaster-based board is formed according to a process known per se which consists in mixing powdered calcined gypsum (calcium sulfate hemihydrate) with water in order to form a paste, which is continuously deposited between two sheets of paper or cardboard.

The product formed is compressed, in order to obtain the desired thickness, and then it is continuously transported on a conveyor over a distance which allows the paste to achieve a level of hardening sufficient to be able to be cut into boards of predetermined length. The boards are subsequently dried in a drying oven in order to remove the excess water.

The thickness of the board thus obtained can vary from 6 to 25 millimeters and is preferably of the order of 12.5 millimeters.

Conventionally, calcium sulfate hemihydrate (CaSO₄.0.5H₂O; calcined gypsum), whether natural or synthetic, that is to say resulting in particular from the desulfurization of power plant gases, undergoes a hydration reaction in the presence of water and is converted into calcium sulfate dihydrate (CaSO₄.2H₂O: gypsum).

The amount of calcined gypsum employed to form the paste generally varies from 50 to 150 parts by weight per 100 parts by weight of water and preferably from 60 to 120 parts.

As indicated above, the textile in accordance with the invention replaces at least one of the coating layers made of paper or of cardboard coating the main faces of the plaster-based board, and/or said textile is incorporated in the core made of plaster.

According to a first alternative form, the plaster-based board comprises a textile which is positioned on one of the main faces of the core made of plaster or is embedded in the plaster.

According to a second alternative form, the plaster-based board comprises two textiles positioned on the two main faces of the core made of plaster, or one textile on one of these faces and the other embedded in the plaster.

According to a third alternative form, the plaster-based board comprises two textiles positioned on the two main faces of the core made of plaster and a third textile embedded in the plaster.

In all the abovementioned alternative forms, the textile incorporated in the core of the board is positioned parallel to the layers of paper, of cardboard or of textile which coat the main faces of the core, and preferably the textile is located at an equal distance from the two coating layers.

However, the incorporation of several identical or different textiles in the plaster core should not be excluded, it being possible for these textiles to be distributed in the thickness of the plaster in a uniform or nonuniform way, and in particular it being possible for these textiles to be juxtaposed.

Another subject matter of the present invention relates to the use of a textile as described above including thermoplastic polymer fibers for improving the acoustic properties, in particular the acoustic insulation properties, of a plaster-based board comprising a core made of plaster positioned between two coating layers, in which said textile constitutes the coating layer or layers and/or is embedded in the core made of plaster. The present invention also relates to a process for improving the acoustic properties of a plaster-based board comprising the provision of a textile as described above including thermoplastic polymer fibers and the incorporation of said textile in the plaster-based board, the textile constituting a coating layer and/or being embedded in the core made of plaster.

Another subject matter of the present invention relates to the use of a plaster-based board in accordance with the invention for improving the acoustic insulation in a building. The present invention also relates to a process for improving the acoustic insulation in a building, comprising the installation of a plaster-based board according to the invention in order to form wall surfaces, false ceilings, floors and/or partition walls.

The plaster-based board in accordance with the invention can be used as is or in combination with another material, for example a mineral or wood wool, or a polymer, in order to form an acoustic and/or thermal panel, or else an interlayer polymer film providing the bonding between two plaster-based boards, in order to form a composite panel.

This board can be used to form wall surfaces, false ceilings, floors and partition walls.

The examples which follow make it possible to illustrate the invention without, however, limiting it.

### EXAMPLES 1 TO 7

Plaster-based boards comprising one or two textiles in accordance with the invention are manufactured under the following conditions:

a) a plaster composition is prepared by introducing 1000 g of calcium sulfate hemihydrate, 5 g of starch, 0.1 g of a setting accelerator (gypsum treated with sucrose), 0.05 g of a setting retarder (Plast Retard L, sold by SICIT 2000) and 750 g of water into a mixer provided with a three-bladed stirrer at the speed of 650 rpm for 15 seconds and then 1850 rpm for 45 seconds.

b) a foam is prepared by introducing 138.5 g of water and 1.4 g of foaming agent (Milifoam®, sold by Huntsman) into a mixer provided with a three-bladed stirrer at the speed of 3300 rpm for 1 minute.

c) the plaster composition obtained in stage a) and 30 g of foam obtained in stage b) are introduced into a mixer provided with a planetary paddle operating at the speed of 250 rpm for 50 seconds, in order to obtain a paste.

d) the paste is poured into a brass mold comprising 4 parallelepipedal cavities (length: 300 mm; width: 30 mm; depth: 13 mm), the internal walls of which are coated with a layer of oil and the bottom of which is coated with a sheet of cardboard or of the textile according to the invention.

When a textile in accordance with the invention is incorporated in the paste, the paste is first poured into the mold over a thickness of 6 mm, then the textile, cut to the size of the mold, is deposited and the mold is filled with the paste.

A sheet of cardboard or a textile, having the size of the mold, is deposited over the paste and the mold is closed with a board on which two weights each of 5 kg are placed.

The boards are removed from the mold after 20 minutes, left in the open air for 10 minutes, then placed in a first drying oven at 180° C. for 35 minutes and in a second drying oven at 100° C. for 25 minutes. The boards are stored in a dry chamber at 40° C.

Example 1 comprises, on one face of the board, a nonwoven composed of polypropylene fibers (80% by weight) and of poly(acrylic acid) fibers (20% by weight) with a weight per unit area equal to 100 g/m² (sold under the reference Fibertex F-80 Extra by Fibertex Nonwoven) and, on the other face, a sheet of cardboard (V5, sold by Saint-Régis).

Example 2 comprises a nonwoven (Fibertex F-80 Extra, sold by Fibertex Nonwoven) on each face of the board.

Example 3 comprises, on one face of the board, a nonwoven consisting of multilobal PET fibers (sold under the reference 4DG® by Fiber Innovation Technology) with a weight per unit area equal to 50 g/m² and, on the other face, a sheet of cardboard (V5, sold by Saint-Régis).

Example 4 comprises, on one face of the board, a nonwoven consisting of multilobal PET fibers (sold under the reference 4DG® by Fiber Innovation Technology) with a weight per unit area equal to 150 g/m² and, on the other face, a sheet of cardboard (V5, sold by Saint-Régis).

Example 5 comprises a nonwoven composed of polypropylene fibers (80% by weight) and of PET fibers (20% by weight) with a weight per unit area equal to 100 g/m² (sold by Fibertex Nonwoven) in the core made of plaster and a sheet of cardboard (V5, sold by Saint-Régis) on each face of the board.

Example 6 comprises a nonwoven composed of polypropylene fibers (80% by weight) and of PET fibers (20% by weight) and including from 4 to 6% by weight of carbon black with a weight per unit area equal to 100 g/m² (sold by Fibertex Nonwoven) in the core made of plaster and a sheet of cardboard (V5, sold by Saint-Régis) on each face of the board.

By way of comparison, a board comprising two sheets of cardboard (V5, sold by Saint-Régis) and not including any textile in accordance with the invention in the core made of plaster was prepared under the same conditions (comparative example 7).

The acoustic performance levels of the boards are evaluated by measuring their mechanical impedance MIM (Measurement of Mechanical Impedance) under the conditions of the standard ISO 16940:2008(E). The dynamic Young's modulus (in GN/m²) and the loss factor η (in %) are calculated from the curve of the acceleration frequency (dB) as a function of the frequency (Hz). The acoustic gain with respect to the board of (comparative) example 7 is also calculated.

The results are given in table 1.

TABLE 1

| | | | | | | | Ex. 7 |
|---|---|---|---|---|---|---|---|
| | Ex. 1 | Ex. 2 | Ex. 3 | Ex. 4 | Ex. 5 | Ex. 6 | (comp.) |
| Weight per unit | 9.30 | 9.00 | 10.00 | 9.80 | 9.40 | 9.13 | 9.11 |
| area (kg/m²) | | | | | | | |
| Dynamic Young's | 2.95 | 2.61 | 3.17 | 2.01 | 0.90 | 2.11 | 3.58 |
| modulus (GN/m²) | | | | | | | |
| Loss factor η (%) | 0.75 | 1.01 | 0.88 | 3.72 | 7.59 | 4.70 | 0.30 |
| Acoustic gain (%) | 17.60 | 27.09 | 11.45 | 43.85 | 74.86 | 48.60 | — |

1. A plaster-based board comprising a core made of plaster positioned between two coating layers, and a textile including thermoplastic polymer fibers, said textile constituting one of the coating layers or the two coating layers and/or being embedded in the core made of plaster.

2. The board as claimed in claim 1, wherein the textile is a nonwoven or a fabric.

3. The board as claimed in claim 1, wherein the textile includes at least 70% by weight of fibers composed of at least one thermoplastic polymer.

4. The board as claimed in claim 1, wherein the thermoplastic polymer is chosen from polyolefins, polyamides, homopolymers and copolymers of acrylonitrile, polyimides, polyesters, poly(lactic acid)s, polyhydroxyalkanoates, vinyl polymers, copolymers of ethylene and of a vinyl compound, (meth)acrylic acid polymers, alkyl (meth)acrylate polymers, polycaprolactones, polystyrenes, polymers of styrene and of an anhydride, copolymers of an olefin and of a fluorinated monomer, polycarbonates, polyketones, polyetherketones, polyethersulfones, polyimides and linear polyurethanes.

5. The board as claimed in claim 4, wherein the thermoplastic polymer is chosen from polypropylene, (meth)acrylic acid or (meth)acrylate polymers, poly(lactic acid)s, polyhydroxyalkanoates, PET, PBT and polyethylene naphthalate.

6. The board as claimed in claim 5, wherein the thermoplastic polymer is polypropylene, a (meth)acrylic acid or (meth)acrylate polymer or PET.

7. The board as claimed in claim 1, wherein the textile includes a mixture of at least two different thermoplastic polymer fibers.

8. The board as claimed in claim 16, wherein the amount of polypropylene fibers represents from 10 to 90% of the total weight of the thermoplastic polymer fibers.

9. The board as claimed in claim 1, wherein the fibers exhibit a linear density which varies from 1 to 25 dtex.

10. The board as claimed in claim 1, wherein the fibers are cut and that their length varies from 0.5 to 15 cm.

11. The board as claimed in claim 1, wherein the thermoplastic polymer fibers have a simple or multilobal section.

12. The board as claimed in claim 1, wherein the textile includes up to 30% by weight of fibers based on a nonthermoplastic polymer or glass fibers.

13. The board as claimed in claim 12, wherein the textile is consolidated by an aqueous binder which contains at least one polymer chosen from copolymers of an olefin and of vinyl acetate, copolymers of vinyl acetate and of (meth)acrylic acid or of acrylate, copolymers of (meth)acrylate and of a monomer other than vinyl acetate, homopolymers of (meth)acrylic acid or of acrylate, terpolymers of vinyl acetate, of an olefin and of a vinyl ester monomer, and acrylonitrile polymers.

14. The board as claimed in claim 1, wherein the textile exhibits a weight per unit area which varies from 50 to 800 g/m².

15. The board as claimed in claim 1, wherein the board has a thickness which varies from 6 to 25 millimeters.

16. The board as claimed in claim 7, wherein the textile includes a mixture of polypropylene fibers and of (meth)acrylic acid or (meth)acrylate polymer fibers or of polypropylene fibers and of PET fibers.

17. The board as claimed in claim 8, wherein the amount of polypropylene fibers is at least equal to 50% of the total weight of the thermoplastic polymer fibers.

18. The board as claimed in claim 17, wherein the amount of polypropylene fibers is at least equal to 70% of the total weight of the thermoplastic polymer fibers.

19. The board as claimed in claim 9, wherein the linear density varies from 5 to 12 dtex.

20. The board as claimed in claim 10, wherein the length of the fibers varies from 2 to 8 cm.

21. The board as claimed in claim 14, wherein the textile exhibits a weight per unit area which varies from 80 to 300 g/m².

22. The board as claimed in claim 15, wherein the board has a thickness that is of the order of 12.5 millimeters.
